(19) United States
(12) Patent Application Publication
(10) Pub. No.: US 2017/0168227 A1
(43) Pub. Date: Jun. 15, 2017

(54) LED LIGHT GUIDE LAMP

(71) Applicant: DynaScan Technology Corp., Taoyuan County (TW)

(72) Inventors: Tsun-I WANG, Taoyuan County (TW); Ching-Chun WU, Taoyuan County (TW); Chia-Liang YANG, Taoyuan County (TW)

(21) Appl. No.: 15/363,934

(22) Filed: Nov. 29, 2016

(30) Foreign Application Priority Data
Dec. 11, 2015 (TW) 104141830

(51) Int. Cl. F21V 8/00

(52) U.S. Cl. CPC G02B 6/0085; G02B 6/0043; G02B 6/0045; G02B 6/0055; G02B 6/0068

(57) ABSTRACT

A LED light guide lamp includes at least one light source, a light guide member and a heat dissipation member. The light source includes a base and a plurality of LEDs, and the LEDs are in thermal contact with the base. The light guide member includes a light receiving surface, a first light emitting surface, a second light emitting surface and a plurality of light scattering microstructures, and the LEDs are disposed on the light receiving surface. The heat dissipation member is disposed on the second light emitting surface of the light guide member and is in thermal contact with the base of the light source. The heat dissipation member extends along the second light emitting surface. The heat dissipation member is fastened to the base, and the heat dissipation member is spaced apart from the light guide member.

### CROSS-REFERENCE TO RELATED APPLICATIONS

This non-provisional application claims priority under 35 U.S.C. §119(a) on Patent Application No(s). 104141830 filed in Taiwan R.O.C. on Dec. 11, 2015, the entire contents of which are hereby incorporated by reference.

### TECHNICAL FIELD

The present disclosure provides a lamp, more particular to a light emitting diode light guide lamp.

### BACKGROUND

Light emitting diode (LED), as a new light source, has been widely used in the field of illumination. A module including multiple light emitting diodes (LEDs) is able to provide high luminance with a high luminous efficacy. The LED module can replace conventional light bulb to become an ideal illumination device characterized in low power consumption, long lifetime and high luminance. A LED light guide lamp has been developed to replace conventional illumination device such as incandescent lamp and fluorescent lamp.

Due to the compact size of the LED chip, the temperature of the LED light source during the illumination in the illumination device easily increases to be overly high, such that it is necessary to dissipate heat generated by the LED light source. A conventional solution is to directly attach a component having high thermal conductivity to the cover of the illumination device, such as a bulb or a tube. However, since the cover is usually made of low thermal conductivity material, such as glass or plastic, the heat transfer between the member and the bulb or the tube is inefficient. In addition, the LED light source is usually spaced apart from the cover, and therefore the heat transfer between the LED light source and the cover is also inefficient, which is also unfavorable for the heat dissipation.

### SUMMARY

According to one aspect of the disclosure, a LED light guide lamp includes at least one light source, a light guide member and a heat dissipation member. The light source includes a base and a plurality of LEDs, and the LEDs are in thermal contact with the base. The light guide member includes a light receiving surface, a first light emitting surface, a second light emitting surface and a plurality of light scattering microstructures, and the LEDs are disposed on the light receiving surface. The heat dissipation member is disposed on the second light emitting surface of the light guide member and is in thermal contact with the base of the light source. The heat dissipation member extends along the second light emitting surface. The heat dissipation member is fastened to the base, and the heat dissipation member is spaced apart from the light guide member.

### BRIEF DESCRIPTION OF THE DRAWINGS

The present disclosure will become better understood from the detailed description given hereinbelow and the accompanying drawings which are given by way of illustration only and thus are not limitative of the present disclosure and wherein:

FIG. 1 is a perspective view of a LED light guide lamp according to a first embodiment of the disclosure;

FIG. 2 is an exploded view of the LED light guide lamp in FIG. 1;

FIG. 3 is a cross sectional view of the LED light guide lamp in FIG. 1;

FIG. 4 is an exploded view of a LED light guide lamp according to a second embodiment of the disclosure;

FIG. 5 is a cross sectional view of the LED light guide lamp in FIG. 4;

FIG. 6 is an exploded view of a LED light guide lamp according to a third embodiment of the disclosure;

FIG. 7 is a cross sectional view of the LED light guide lamp in FIG. 6;

FIG. 8 is a cross sectional view of a LED light guide lamp according to a fourth embodiment of the disclosure; and

FIG. 9 is a cross sectional view of a LED light guide lamp according to a fifth embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

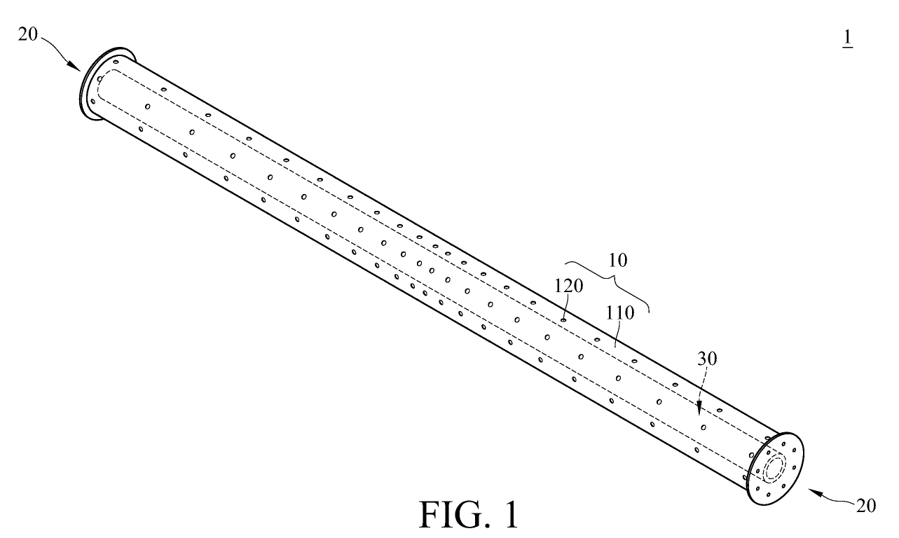

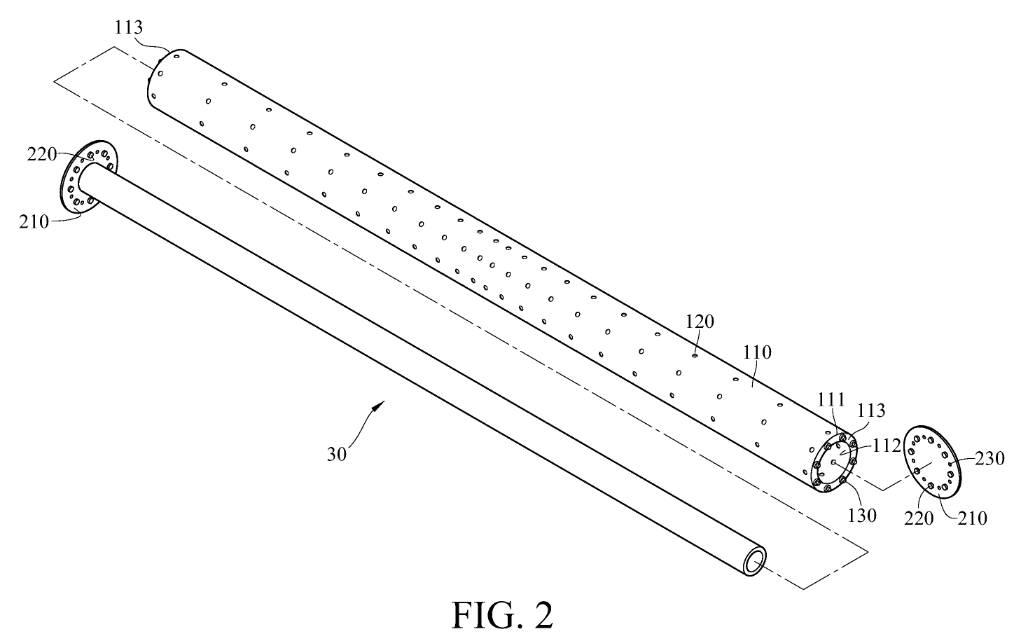

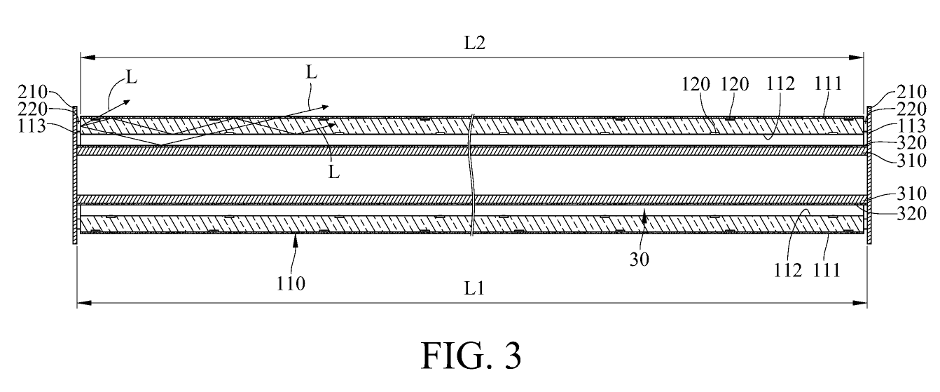

Please refer to FIG. 1 through FIG. 3. FIG. 1 is a perspective view of a LED light guide lamp according to a first embodiment of the disclosure. FIG. 2 is an exploded view of the LED light guide lamp in FIG. 1. FIG. 3 is a cross sectional view of the LED light guide lamp in FIG. 1. In this embodiment, the LED light guide lamp 1 includes a light guide member 10, two light sources 20, and a heat dissipation member 30. The quantity of the light source 20 is changeable in the manufacturing process of the LED light guide lamp according to different demands so that the disclosure is not limited thereto.

The light guide member 10 includes a main body 110 and a plurality of light scattering microstructures 120 disposed on the main body 110. The light guide member 10 is made of glass material, plastic material such as acrylic, or other light-transmittable materials. The light guide member 10 is a hollow bar, and the main body 110 of the light guide member 10 has a first light emitting surface 111, a second light emitting surface 112 and two circular light receiving surfaces 113. The circular light receiving surfaces 113 are located between the first light emitting surface 111 and the second light emitting surface 112. The light scattering microstructures 120 are disposed on the first light emitting surface 111 and the second light emitting surface 112. In this embodiment, the first light emitting surface 111 is an outer surface of the light guide member 10 facing towards external environment, and the second light emitting surface 112 is an inner surface facing towards the inside of the LED light guide lamp 1. In this embodiment, each of the light scattering microstructures 120 is a recess or a protrusion formed on the first light emitting surface 111 or the second light emitting surface 112, and each of the light scattering microstructures 120 has a size ranging from several micrometers to several hundred micrometers. In some other embodiments, the light scattering microstructure 120 is an additional lens element which are attached to the first light emitting surface 111 or the second light emitting surface 112.The light scattering microstructures 120 are configured to prevent total internal refraction and scatter light emitted from the LED light guide lamp 1, such that the light emitted from the LED light guide lamp 1 is diffused to have equal luminance in all directions.

The two light sources 20 are respectively disposed on opposite two sides of the main body 110, and the two light sources 20 are respectively located on the two circular light receiving surfaces 113 of the main body 110. Each of the light sources 20 includes a base 210 and a plurality of LEDs 220. The base 210 is a metal board, a ceramics board, a printed circuit board containing lead or other material having high thermal conductivity, and each of the LEDs 220 is a LED chip which is able to emit visible light. The LEDs 220 are disposed between the main body 110 and the base 210. In detail, the circular light receiving surface 113 of the light guide member 10 faces towards the base 210 and the LEDs 220, and the LEDs 220 are disposed on the circular light receiving surface 113. In this and some embodiments, the LEDs 220 are spaced apart from the circular light receiving surface 113, but the disclosure is not limited thereto. In other embodiments, the LEDs are directly attached to the circular light receiving surface 113. In this embodiment, the LEDs 220 are arranged in a circular form or other forms according to specific luminance requirement. Moreover, the LEDs 220 are in thermal contact with the base 210, such that the heat generated by the LEDs 220 during illumination is transferred to the base 210. In this embodiment, the base 210 is fastened to the main body 110 of the light guide member 10, such that it is favorable for preventing the light guide member 10 from displacement, thereby the collisions between the light guide member 10 and other members of the LED light guide lamp 1 are reduced. For example, in FIG. 2, the main body 110 includes multiple fastening blocks 130 which are respectively fastened to multiple slots 230 on the base 210.

The heat dissipation member 30 is configured to dissipate the heat generated by the LEDs 220. The heat dissipation member 30 is disposed on the second light emitting surface 112 and in thermal contact with the base 210. In detail, the heat dissipation member 30 is located on a side of the light guide member 10 close to the second light emitting surface 112 and in thermal contact with the base 210. The heat dissipation member 30 extends relative to the light guide member 10 along the second light emitting surface 112. In detail, the heat dissipation member 30 extends along a direction perpendicular to the normal line of the second light emitting surface 112; or, the heat dissipation member 30 extends along a direction enclosing an acute angle with the normal line of the second light emitting surface 112. The heat dissipation member 30 is a hollow bar disposed through the light guide member 10; and therefore, the light guide member 10 surrounds the heat dissipation member 30 to cover the heat dissipation member 30. The second light emitting surface 112 of the light guide member 10 faces towards the heat dissipation member 30, and two opposite ends of the heat dissipation member 30 are respectively fixed to the two bases of the two light sources 20. The heat dissipation member 30 is spaced apart from the light guide member 10, and the LEDs 220 are arranged on the circular light receiving surface 113 to surround the heat dissipation member 30. In this embodiment, the heat dissipation member 30 is firmly attached to the base 210 by thermally conductive adhesive, but the disclosure is not limited thereto. In some other embodiments, the heat dissipation member includes a hook, the base includes a hole, and the hook of the heat dissipation member is fastened to the hole of the base.

Furthermore, as shown in FIG. 3, the heat dissipation member 30 includes a heat dissipation layer 310 and a light reflection layer 320. The heat dissipation layer 310 is in thermal contact with the base 210, and at least a part of the light reflection layer 320 is disposed between the heat dissipation layer 310 and the main body 110 of the light guide member 10. The heat dissipation layer 310 is a metal bar or a ceramic bar, and the light reflection layer 320 is a light reflection material coated on a side of the heat dissipation layer 310 facing towards the light guide member 10. For example, the light reflection layer 320 is made of a material including barium sulfate (BaSOₓ), such that the heat dissipation member 30 appears white and smooth.

Moreover, a length L1 of the heat dissipation member 30 is equal to or larger than a length L2 of the light guide member 10. Therefore, most of the internal space of the LED light guide lamp 1 is effectively used for accommodating the heat dissipation member 30 to increase the heat dissipation area on the heat dissipation member 30, thereby improving the heat dissipation efficiency of the heat dissipation layer 310.

As shown in FIG. 3, each of the LEDs 220 is able to emit a light beam L, and the light beam L enters into the main body 110 through the circular light receiving surface 113. When the LEDs 220 illuminate continuously, the temperature of the LEDs 220 is increased. The heat generated by the LED 220 is transferred to the base 210 and then transferred to the heat dissipation layer 310 of the heat dissipation member 30 to prevent the temperature of the LEDs 220 from overly high. In detail, the heat dissipation member 30 is favorable for providing additional area for the heat dissipation to the LEDs 220 so as to improve heat dissipation efficiency.

When the light beam L emitted from the LED 220 travels to the first light emitting surface 111 or the second light emitting surface 112 of the main body 110, the total internal reflection occurs at the first light emitting surface 111 or the second light emitting surface 112 if an incident angle of the light beam L is larger than a critical angle; thereby, the light beam L is trapped in the main body 110 and travels along the axis direction of the main body 110. In contrast, the light beam L is emitted from the first light emitting surface 111 or the second light emitting surface 112 if the incident angle is smaller than the critical angle. When the light beam L travels to the light scattering microstructure 120, the light scattering microstructure 120 scatters the light beam L, such that the light beam L travels out of the main body 110 instead of being trapped therein, thereby improving the light extraction efficiency to enhance the amount of light emitted from the LED light guide lamp 1.

Furthermore, the light beam L emitted from the second light emitting surface 112 travels to the light reflection layer 320 of the heat dissipation member 30, and the light beam L is reflected by the light reflection layer 320 to travel back into the main body 110 through the second light emitting surface 112, and then travel to external environment through the first light emitting surface 111. Thus, the heat dissipation member 30 is favorable for reflecting the light beam L emitted from the second light emitting surface 112 back into the main body 110, and then the reflected light beam L emits to external environment from the first light emitting surface 111 to further improve the light extraction efficiency. As a result, the amount of light emitted from the LED light guide lamp 1 is improved. In this embodiment, the light beam L is reflected by the light reflection layer 320 of the heat dissipation member 30, but the disclosure is not limited thereto. In some other embodiments, the heat dissipation member includes no light reflection layer, and the heat dissipation layer of the heat dissipation member is polished to have smooth outer surface which is adapted for light reflection.

According to the disclosure, the heat generated by the LEDs 220 are transferred to the dissipation layer 310 of the heat dissipation member 30 through the base 210, and both the base 210 and the heat dissipation member 30 are good heat conductors. Therefore, it is favorable for preventing the temperature of the LEDs 220 from overly high. Furthermore, the heat dissipation member 30 is favorable for reflecting the light beam L emitted from the second light emitting surface 112 back into the main body 110, and then the reflected light beam L emits to external environment from the first light emitting surface 111 to further improve the light extraction efficiency, thereby enhancing the amount of light emitted from the LED light guide lamp 1.

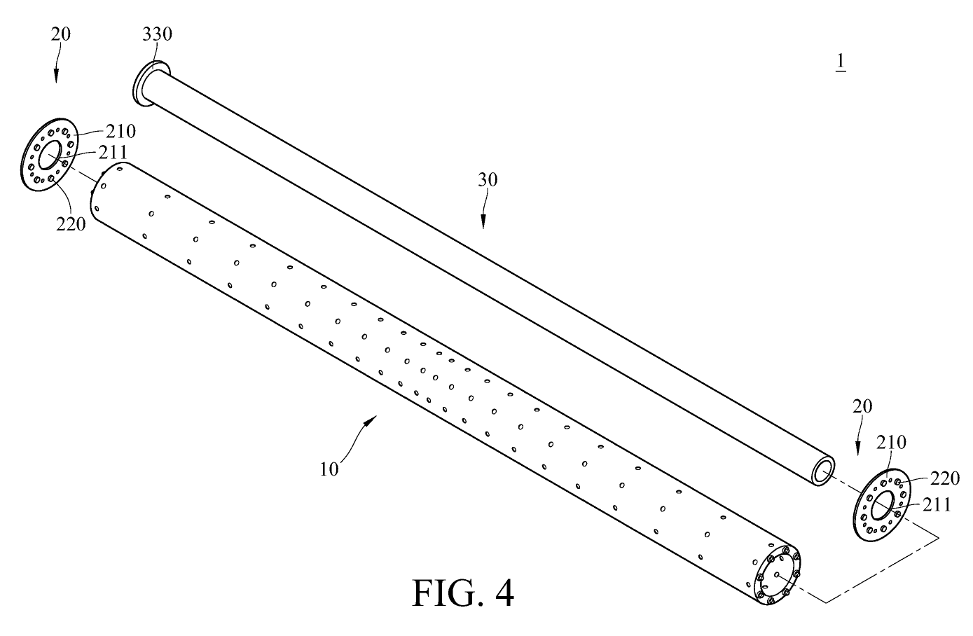

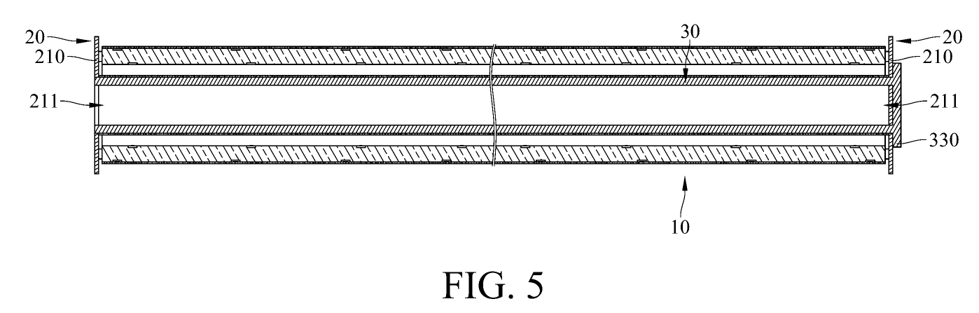

The heat dissipation member is firmly adhered to the base of the light source to be in thermal contact with each other in the first embodiment, but the disclosure is not limited thereto. Please refer to FIG. 4 and FIG. 5. FIG. 4 is an exploded view of a LED light guide lamp according to a second embodiment of the disclosure. FIG. 5 is a cross sectional view of the LED light guide lamp in FIG. 4. Since the second embodiment is similar to the first embodiment, only the differences will be illustrated hereafter.

In this embodiment, the base 210 of each of the light sources 20 has an opening 211, and the heat dissipation member 30 has a flange 330. The heat dissipation member 30 is disposed through the opening 211 and extends along the axis of the light guide member 10. The flange 330 is abutted against a side of the base 210 away from the light guide member 10. Therefore, the heat dissipation member 30 is in thermal contact with the base 210 without adhesion. In this embodiment, there is one or more holes (not shown in the drawings) on the periphery of the flange 330, and there is also one or more holes on the base 210, wherein a screw is screwed to the hole. Furthermore, the opening 211 of the base 210 exposes the inside of the heat dissipation member 30 to external environment, such that the air flow passes across the heat dissipation member 30 through the opening 211 to improve the heat dissipation efficiency. For example, there may be two fans (not shown in the drawings) respectively disposed on the two opposite ends of the heat dissipation member 30. The air flow generated by the fans helps the heat dissipation of the LEDs.

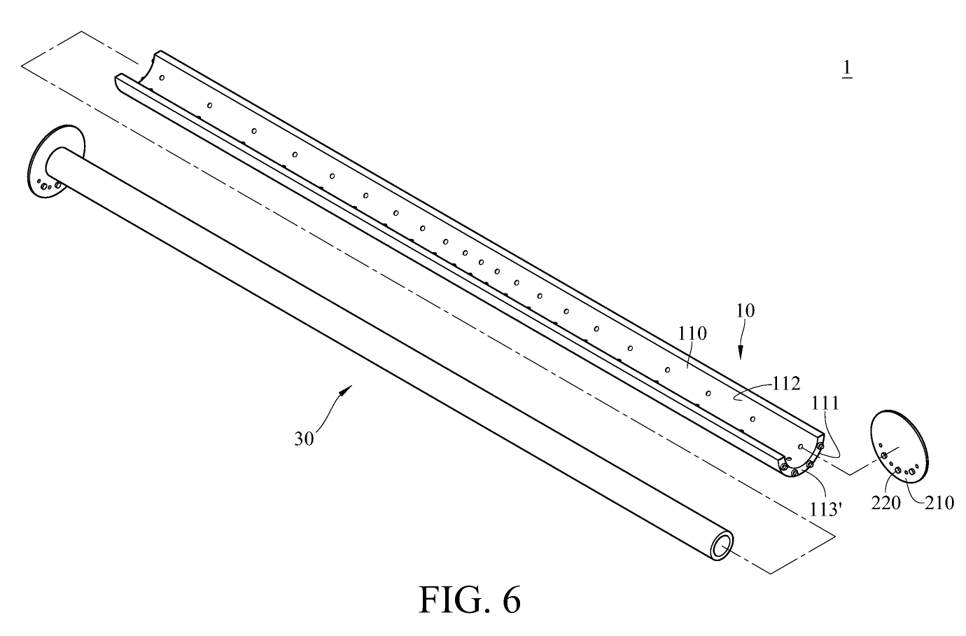

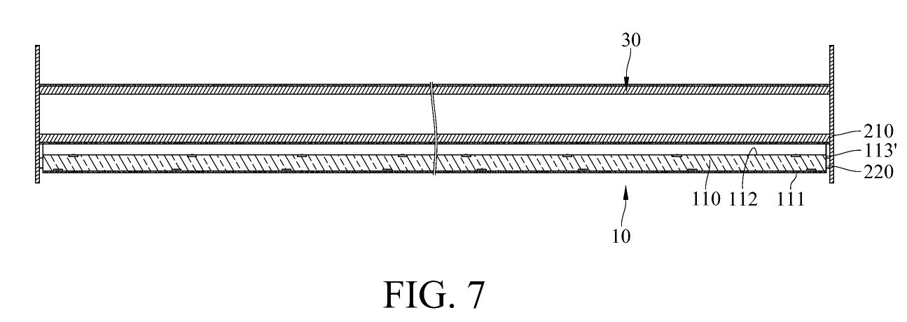

The light guide member is a hollow bar in the first embodiment, but the disclosure is not limited thereto. Please refer to FIG. 6 and FIG. 7. FIG. 6 is an exploded view of a LED light guide lamp according to a third embodiment of the disclosure. FIG. 7 is a cross sectional view of the LED light guide lamp in FIG. 6. Since the third embodiment is similar to the first embodiment, only the differences will be illustrated hereafter.

In this embodiment, the light guide member 10 is a curved plate having a curved light receiving surface 113′ located on the main body 110. The first light emitting surface 111 is a convex side of the main body 110, and the second light emitting surface 112 is a concave side of the main body 110. The heat dissipation member 30 is disposed on the concave side of the main body 110. The light guide member 10 only covers the bottom part of the heat dissipation member 30 while the top part of the heat dissipation member 30 is exposed to external environment, and thereby, it is favorable for improving the heat dissipation efficiency.

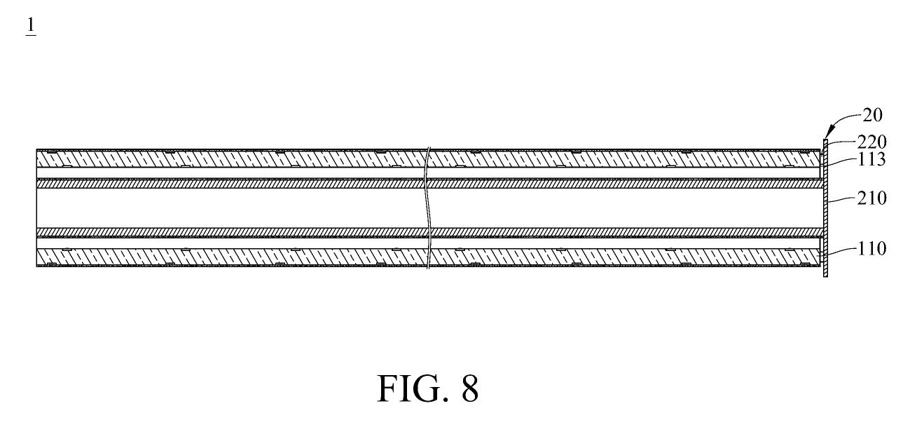

The quantity of the light source is two in the first embodiment, but the disclosure is not limited thereto. Please refer to FIG. 8, which is a cross sectional view of a LED light guide lamp according to a fourth embodiment of the disclosure. Since the fourth embodiment is similar to the first embodiment, only the differences will be illustrated hereafter. In this embodiment, the quantity of the light source 20 is one, and the light source 20 is disposed on one of the two circular light receiving surfaces 113 of the light guide member 10.

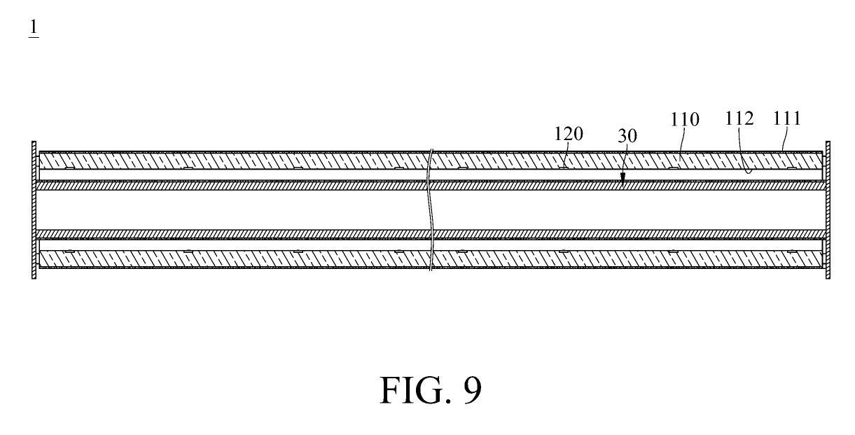

In the first embodiment, some light scattering microstructures are disposed on the first light emitting surface, and some other light scattering microstructures are disposed on the second light emitting surface, but the disclosure is not limited thereto. Please refer to FIG. 9, which is a cross sectional view of a LED light guide lamp according to a fifth embodiment of the disclosure. Since the fifth embodiment is similar to the first embodiment, only the differences will be illustrated hereafter.

In this embodiment, the light scattering microstructures 120 are all disposed on the second light emitting surface 112; that is, there is no light scattering microstructure on the first light emitting surface 111. Light emitted from the LED 220 is scattered by the light scattering microstructure 120 located on the second light emitting surface 112, and the light emitted from the second light emitting surface 112 is reflected back by the light reflection layer 320 of the heat dissipation member 30 to emit from the first light emitting surface 111. Since there is no light scattering microstructure on the first light emitting surface 111, the LED light guide lamp 1 has better appearance.

According to the disclosure, the internal space of the light guide member is effectively used for accommodating the heat dissipation member, and the heat dissipation member extends along the second light emitting surface to provide additional area for heat dissipation. The heat dissipation member is in thermal contact with the base of the light source, and the heat dissipation member is spaced apart from the light guide member. Therefore, the heat generated by the LEDs is effectively transmitted to the heat dissipation member through the base which is a good heat conductor, such that it is favorable for preventing the temperature of the LEDs from overly high.

Furthermore, the light emitted from the second light emitting surface is reflected by the heat dissipation member to travel back into the light guide member, and the reflected light travels to external environment from the first light emitting surface to improve the light extraction efficiency, thereby enhancing the amount of light emitted from the LED light guide lamp.

The foregoing description, for the purpose of explanation, has been described with reference to specific embodiments; however, the embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the disclosure to the precise forms disclosed. Modifications and variations are possible in view of the above teachings.

What is claimed is:

1. A LED light guide lamp, comprising:
at least one light source comprising a base and a plurality of LEDs, and the plurality of LEDs in thermal contact with the base;
a light guide member comprising a main body and a plurality of light scattering microstructures, the main body having a light receiving surface, a first light emitting surface and a second light emitting surface, the plurality of light scattering microstructures disposed on the main body, and the plurality of LEDs disposed on the light receiving surface; and
a heat dissipation member disposed on the second light emitting surface of the light guide member and in thermal contact with the base of the at least one light source, the heat dissipation member extending along the second light emitting surface, and the heat dissipation member fastened to the base and spaced apart from the light guide member.

2. The LED light guide lamp according to claim 1, wherein the light guide member is a hollow bar, and the heat dissipation member is disposed through the light guide member.

3. The LED light guide lamp according to claim 1, wherein the light guide member is a curved plate, and the heat dissipation member is disposed on a concave side of the light guide member.

4. The LED light guide lamp according to claim 1, wherein the heat dissipation member is longer than or equal to the light guide member.

5. The LED light guide lamp according to claim 1, wherein the heat dissipation member is a hollow bar.

6. The LED light guide lamp according to claim 1, wherein the heat dissipation member comprises a light reflection layer and a heat dissipation layer, the heat dissipation layer is in thermal contact with the base of the at least one light source, and the light reflection layer is disposed between the heat dissipation layer and the light guide member.

7. The LED light guide lamp according to claim 6, wherein the light reflection layer is made of a material comprising barium sulfate.

8. The LED light guide lamp according to claim 1, wherein a quantity of the at least one light source is two, the two light sources are respectively disposed on two ends of the light guide member that are opposite to each other, and two ends of the heat dissipation member that are opposite to each other are respectively fastened to and in thermal contact with the two bases of the two light sources.

9. The LED light guide lamp according to claim 1, wherein the plurality of light scattering microstructures are disposed on the second light emitting surface of the light guide member.

10. The LED light guide lamp according to claim 1, wherein the plurality of light scattering microstructures are disposed on the first light emitting surface of the light guide member.

11. The LED light guide lamp according to claim 1, wherein the base of the at least one light source has an opening, and the heat dissipation member is disposed through the opening.
